(19) United States
(12) Patent Application Publication
(10) Pub. No.: US 2025/0121634 A1
(43) Pub. Date: Apr. 17, 2025

(54) PNEUMATIC TIRE

(71) Applicant: Sumitomo Rubber Industries, Ltd., Kobe-shi (JP)

(72) Inventors: Sho MATSUNAMI, Kobe-shi (JP); Naoki YUKAWA, Kobe-shi (JP); Takuya SATO, Kobe-shi (JP)

(73) Assignee: Sumitomo Rubber Industries, Ltd., Kobe-shi (JP)

(21) Appl. No.: 18/916,881

(22) Filed: Oct. 16, 2024

(30) Foreign Application Priority Data
Oct. 16, 2023 (JP) 2023-178405

(51) Int. Cl. B60C 19/00

(52) U.S. Cl. CPC B60C 19/002

(57) ABSTRACT

A pneumatic tire can include a plurality of Helmholtz sound absorbers on a tire inner cavity surface. The plurality of Helmholtz sound absorbers can have a first resonance frequency as a maximum resonance frequency and a second resonance frequency as a minimum resonance frequency. A difference between the first resonance frequency and the second resonance frequency can be 10 to 90 Hz.

### CROSS REFERENCE TO RELATED APPLICATION(S)

The present application claims priority to Japanese patent application JP 2023-178405, filed Oct. 16, 2023, the entire content of which is incorporated herein by reference in its entirety.

### BACKGROUND

### Field

The present disclosure relates to a pneumatic tire capable of decreasing cavity resonance sound.

Japanese Patent No. 6289506 proposes a pneumatic tire having an inner circumferential surface mounted with a large number of resonators which are Helmholtz sound absorbers.

However, the pneumatic tire in Japanese Patent No. 6289506 is understood to be required to have a large number of the Helmholtz sound absorbers having different resonance frequencies in order to deal with cavity resonance sound, in the tire, that differs according to the running speed. Thus, regarding this pneumatic tire, further enhancement may be required in terms of manufacturing and in terms of weight as well.

### SUMMARY

According to an aspect of the present disclosure, a pneumatic tire including a plurality of Helmholtz sound absorbers disposed on a tire inner cavity surface can be made, implemented, or otherwise provided, wherein the plurality of Helmholtz sound absorbers can have a first resonance frequency as a maximum resonance frequency and a second resonance frequency as a minimum resonance frequency, and a difference between the first resonance frequency and the second resonance frequency can be 10 to 90 Hz.

### BRIEF DESCRIPTION OF THE DRAWINGS

FIG. 1 is a cross-sectional view showing a pneumatic tire according to one or more embodiments of the present disclosure;

FIG. 2 is a schematic cross-sectional view of the pneumatic tire of FIG. 1 as seen in a tire axial direction;

FIG. 3 is a perspective view of a Helmholtz sound absorber according to one or more embodiments of the present disclosure;

FIG. 4 is a perspective view of a Helmholtz sound absorber according to one or more embodiments of the present disclosure;

FIG. 5 is a perspective view of a Helmholtz sound absorber according to one or more embodiments of the present disclosure; and

FIG. 6 is a cross-sectional view of a pneumatic tire according to one or more embodiments of the present disclosure.

### DETAILED DESCRIPTION

Hereinafter, embodiments of the present disclosure will be described in detail with reference to the drawings.

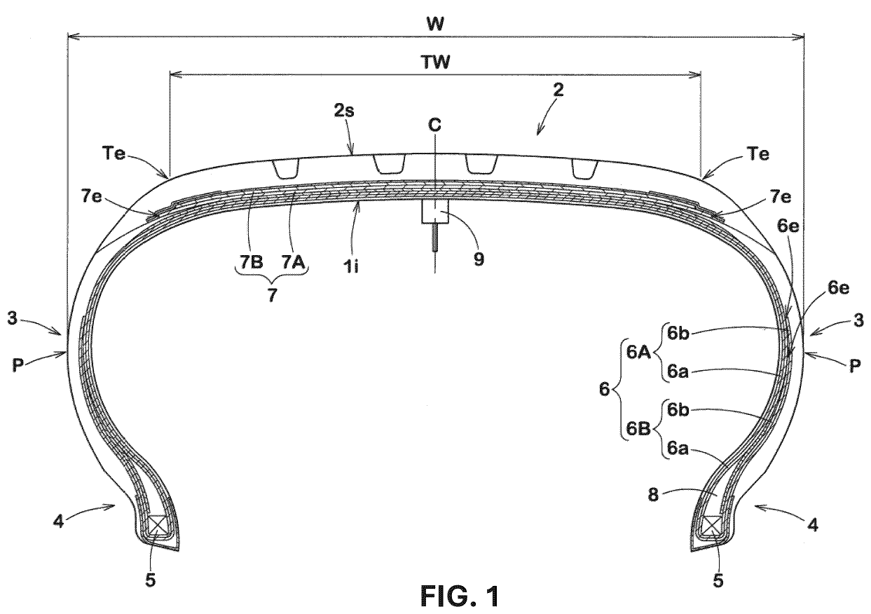

FIG. 1 is a tire meridian cross-sectional view showing a pneumatic tire 1 in a standardized state according to one or more embodiments of the present disclosure. Here, the term “standardized state” can refer to a state where: the pneumatic tire 1 is mounted on a standardized rim and adjusted to a standardized internal pressure; and no load is applied to the pneumatic tire 1. Hereinafter, dimensions and the like of constituents of the pneumatic tire 1 are values measured in the standardized state, unless otherwise specified.

One or more embodiments of present disclosure have been made in view of the above circumstances in the Background section, and a object of one or more embodiments the present disclosure, among one or more objects, can be to provide a pneumatic tire capable of decreasing cavity resonance sound with a relatively simple configuration.

The pneumatic tire according to the present disclosure can have the above configuration, as an example, and thus can decrease cavity resonance sound with a relatively simple configuration.

If there is a standard system including a standard on which the pneumatic tire 1 is based, the term “standardized rim” can be regarded a rim defined for each tire by the standard and may be, for example, the “standard rim” in the JATMA standard, the “Design Rim” in the TRA standard, or the “Measuring Rim” in the ETRTO standard. If there is no standard system including a standard on which the pneumatic tire 1 is based, the term “standardized rim” can be regarded as a rim having the smallest rim diameter and having the smallest rim width, among rims on which the pneumatic tire 1 can be mounted and which do not cause air leakage.

If there is a standard system including a standard on which the pneumatic tire 1 is based, the term “standardized internal pressure” can be regarded as an air pressure defined for each tire by the standard and is the “maximum air pressure” in the JATMA standard, the maximum value indicated in the table “TIRE LOAD LIMITS AT VARIOUS COLD INFLATION PRESSURES” in the TRA standard, or the “INFLATION PRESSURE” in the ETRTO standard, as examples. If there is no standard system including a standard on which the pneumatic tire 1 is based, the term “standardized internal pressure” can be regarded as an air pressure defined for each tire by the manufacturer or the like.

As shown in FIG. 1, the pneumatic tire 1 according to one or more embodiments of the present disclosure suitably used as a tire for passenger cars, for instance. The pneumatic tire 1 is not limited to a tire for passenger cars and can be applicable to various tires such as a heavy-duty tire, a tire for motorcycles, a tire for racing vehicles, and a tire for industrial vehicles, for example.

The pneumatic tire 1 according to one or more embodiments of the present disclosure can include a tread portion 2, a pair of sidewall portions 3, and a pair of bead portions 4. Each of the sidewall portions 3 can be, for example, a portion extending to an inner side in a tire radial direction from a corresponding one of both ends in a tire axial direction of the tread portion 2. Each of the bead portions 4 can be, for example, a portion located on the inner side in the tire radial direction relative to a corresponding one of the sidewall portions 3. The bead portion 4 in one or more embodiments of the present disclosure can be a portion in contact with the standardized rim.

Each of the pair of bead portions 4 can have, for example, an annular bead core 5 extending in a tire circumferential direction and a bead apex 8 extending to an outer side in the tire radial direction from the bead core 5. The bead core 5 can be formed of, for example, a steel wire. The bead apex 8 can be formed of, for example, hard rubber. Such a bead portion 4 can have a relatively high rigidity. Thus, the bead portion 4 can suppress deformation during running and can contribute to decrease of cavity resonance sound in the pneumatic tire 1.

The pneumatic tire 1 according to one or more embodiments of the present disclosure can include: a carcass 6 extending between the pair of bead portions 4; and a belt layer 7 disposed in the tread portion 2. The belt layer 7 can be disposed on the outer side in the tire radial direction relative to the carcass 6, for example. According to one or more embodiments, the pneumatic tire 1 can include a tire inner cavity surface 1i which is located inward of the carcass 6 and which delimits a tire inner cavity.

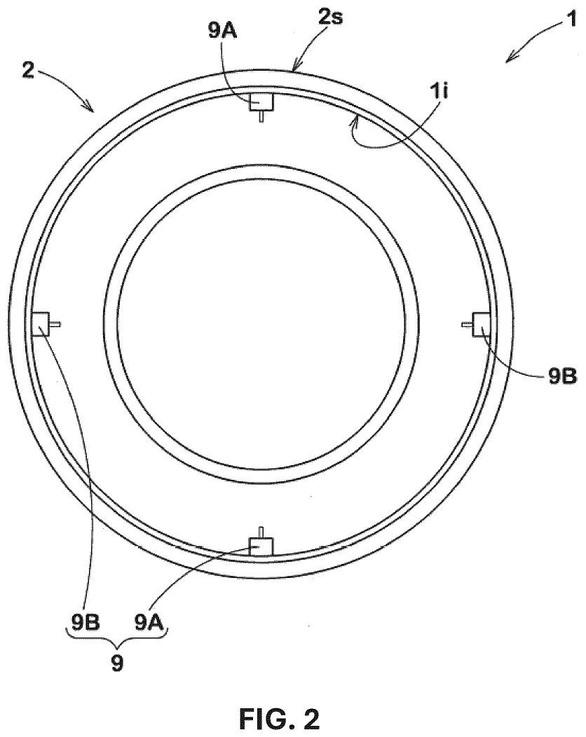

FIG. 2 is a schematic cross-sectional view of the pneumatic tire 1 as seen in the tire axial direction. As shown in FIG. 1 and FIG. 2, the pneumatic tire 1 according to one or more embodiments of the present disclosure can include a plurality of Helmholtz sound absorbers 9 disposed on the tire inner cavity surface 1i. The plurality of Helmholtz sound absorbers 9 in one or more embodiments of the present disclosure can have a first resonance frequency f1 as a maximum resonance frequency fmax and a second resonance frequency f2 as a minimum resonance frequency fmin. Such a pneumatic tire 1 can resonate at the plurality of frequencies, and thus can decrease cavity resonance sound, in the tire, that differs according to the running speed.

A difference (f1−f2) between the first resonance frequency f1 and the second resonance frequency f2 can be 10 to 90 Hz, as an example, according to one or more embodiments of the present disclosure. Such a pneumatic tire 1 can efficiently decrease cavity resonance sound generated at a running speed of 10 to 200 km/h, for instance, and can enable decrease in the number of the Helmholtz sound absorbers 9. Consequently, the pneumatic tire 1 according to one or more embodiments of the present disclosure can decrease the cavity resonance sound with a relatively less complex configuration. From this viewpoint, the difference (f1−f2) between the first resonance frequency f1 and the second resonance frequency f2 optionally may be 10 to 60 Hz.

Optionally, the first resonance frequency f1 of the Helmholtz sound absorbers 9 can be 130 to 350 Hz, for instance. The second resonance frequency f2 of the Helmholtz sound absorbers 9 can be 120 to 340 Hz, for instance. Such Helmholtz sound absorbers 9 can cover a frequency band of cavity resonance sound generated by a tire for passenger cars and can efficiently decrease the cavity resonance sound in a tire for passenger cars.

As shown in FIG. 1, for instance, the carcass 6 can include at least one carcass ply, and in one or more embodiments of the present disclosure, can include two carcass plies 6A and 6B. The two carcass plies 6A and 6B can be, for example, a first carcass ply 6A located, in the tread portion 2, on the inner side in the tire radial direction and a second carcass ply 6B located, in the tread portion 2, on the outer side in the tire radial direction relative to the first carcass ply 6A.

At least one of the carcass plies 6A and 6B can include: a body portion 6a extending from the tread portion 2 through the sidewall portions 3 to the bead cores 5 of the bead portions 4; and turned-up portions 6b contiguous with the body portion 6a and turned up around the respective bead cores 5 from an inner side to an outer side in the tire axial direction. In one or more embodiments of the present disclosure, each of the first carcass ply 6A and the second carcass ply 6B can include the body portion 6a and the turned-up portions 6b. Such a carcass 6 can contribute to improvement of the rigidities of the bead portions 4 and decrease of cavity resonance sound in the pneumatic tire 1.

At least one of the carcass plies 6A and 6B can be such that an outer end 6e in the tire radial direction of each of the turned-up portions 6b is located on the outer side in the tire radial direction relative to a tire maximum width position P at which a tire cross-sectional width W is maximum. The carcass 6 can be, for example, such that: the outer end 6e of the turned-up portion 6b of the first carcass ply 6A is located on the outer side in the tire radial direction relative to the tire maximum width position P; and the outer end 6e of the turned-up portion 6b of the second carcass ply 6B is located on the inner side in the tire radial direction relative to the tire maximum width position P. Such a carcass 6 can achieve both the rigidities of the sidewall portions 3 and decrease in weight, and can decrease cavity resonance sound in, and the rolling resistance of, the pneumatic tire 1.

Each of the carcass plies 6A and 6B can include, for example, carcass cords which can be organic fiber cords. Examples of the organic fiber cords can include: single-fiber cords each made from one type of fiber selected from the group consisting of polyethylene terephthalate fibers, polyethylene naphthalate fibers, nylon fibers, aramid fibers, and rayon fibers; and hybrid-fiber cords each made from two or more types of fibers selected from said group.

According to one or more embodiments, the carcass cords can be arranged at an angle of 25 to 90° relative to the tire circumferential direction. If the carcass cords are tilted at an angle of smaller than 90° relative to the tire circumferential direction, the carcass cords of the first carcass ply 6A and the carcass cords of the second carcass ply 6B can be tilted in mutually opposite directions relative to the tire circumferential direction. For the carcass 6, for example, a bias structure may be employed. Here, the angle of each of the carcass cords can be an angle obtained with the pneumatic tire 1 being in the standardized state and can be ascertained by, for example, partially peeling the tread portion 2.

The belt layer 7 can include at least one belt ply such as two or more belt plies. According to one or more embodiments of the present disclosure, the belt layer 7 can include two belt plies 7A and 7B. The two belt plies 7A and 7B can be, for example, a first belt ply 7A located on the inner side in the tire radial direction and a second belt ply 7B located on the outer side in the tire radial direction relative to the first belt ply 7A. The belt layer 7 according to one or more embodiments of the present disclosure can have outer ends 7e which are outer ends 7e in the tire axial direction of the first belt ply 7A. Such a belt layer 7 can improve the rigidity of the tread portion 2 and can decrease cavity resonance sound in the pneumatic tire 1.

Each of the belt plies 7A and 7B may include, for example, belt cords which can be steel cords. The belt cords may each be, for example, a single steel wire or a twisted wire obtained by twisting a plurality of steel filaments together.

The belt cords can be arranged at, for example, an angle of 10 to 30° relative to the tire circumferential direction. The belt cords of the first belt ply 7A and the belt cords of the second belt ply 7B can be tilted in mutually opposite directions relative to the tire circumferential direction.

Such a belt layer 7 can improve the rigidity of the tread portion 2 in a balanced manner and can decrease cavity resonance sound in the pneumatic tire 1. Here, the angle of each of the belt cords can be an angle obtained with the pneumatic tire 1 being in the standardized state and can be ascertained by, for example, partially peeling the tread portion 2.

The tread portion 2 according to one or more embodiments of the present disclosure can have a ground-contact surface 2s extending between a pair of tread ends Te. Here, the tread ends Te can be regarded as outermost ground-contact positions in the tire axial direction when: 70% of a standardized load is applied to the pneumatic tire 1 in the standardized state; and the pneumatic tire 1 in this state is brought into contact with a flat surface at a camber angle of 0°. The ground-contact surface 2s can have a tire tread width TW which can be regarded as the distance in the tire axial direction between the pair of tread ends Te. The center position in the tire axial direction between the pair of tread ends Te can be regarded as a tire equator C.

If there is a standard system including a standard on which the pneumatic tire 1 is based, the term “standardized load” can be regarded as a load defined for each tire by the standard and is the “maximum load capacity” in the JATMA standard, the maximum value indicated in the table “TIRE LOAD LIMITS AT VARIOUS COLD INFLATION PRESSURES” in the TRA standard, or the “LOAD CAPACITY” in the ETRTO standard, as examples. If there is no standard system including a standard on which the pneumatic tire 1 is based, the term “standardized load” can be regarded as a load defined for each tire by the manufacturer or the like as a maximum load that can be applied during use of the pneumatic tire 1.

Each of the plurality of Helmholtz sound absorbers 9 according to one or more embodiments of the present disclosure can be disposed on the inner side in the tire radial direction relative to the ground-contact surface 2s. That is, each of the plurality of Helmholtz sound absorbers 9 can be disposed within the range of the tire tread width TW with the tire equator C being the center of the range. According to one or more embodiments of the present disclosure, the plurality of Helmholtz sound absorbers 9 can be arranged in one row on the tire equator C, for example. Such Helmholtz sound absorbers 9 can receive force in such a direction as to be pressed against the tire inner cavity surface 1i when centrifugal force is applied, whereby the risk that the Helmholtz sound absorbers 9 peeling from the tire inner cavity surface 1i can be decreased.

Each of the outer ends 7e of the belt layer 7 according to one or more embodiments of the present disclosure can be located on the outer side in the tire axial direction relative to a corresponding one of the tread ends Te. Such a belt layer 7 can improve the rigidity of the entirety of the ground-contact surface 2s of the tread portion 2 and can contribute to decrease of cavity resonance sound in the pneumatic tire 1.

Each of the plurality of Helmholtz sound absorbers 9 according to one or more embodiments of the present disclosure can be disposed on the inner side in the tire radial direction relative to the belt layer 7. With such a Helmholtz sound absorber 9, since deformation of the tread portion 2 upon contact with the ground can be suppressed by the belt layer 7 having a relatively high rigidity, resonance sound generated from the Helmholtz sound absorber 9 owing to impact upon the contact with the ground can be suppressed.

As shown in FIG. 2, the plurality of Helmholtz sound absorbers 9 can be arranged away from each other. The plurality of Helmholtz sound absorbers 9 can be arranged away from each other in the tire circumferential direction, for example. Such Helmholtz sound absorbers 9 can decrease cavity resonance sound over the entire region of the pneumatic tire 1.

The plurality of Helmholtz sound absorbers 9 according to one or more embodiments of the present disclosure can include a plurality of first sound absorbers 9A each having the first resonance frequency f1 and a plurality of second sound absorbers 9B each having the second resonance frequency f2. According to one or more embodiments of the present disclosure, the number of the first sound absorbers 9A provided in each of rows arranged in the tire circumferential direction can be an even number, and the number of the second sound absorbers 9B provided in each of the rows can be an even number. Optionally, the number of first sound absorbers 9A may be the same as the number of second sound absorbers 9B. Such Helmholtz sound absorbers 9 can facilitate adjustment of balance at the time of rotation of the tire. Although Helmholtz sound absorbers can be arranged in one row as an example of the plurality of Helmholtz sound absorbers 9, the plurality of Helmholtz sound absorbers 9 may be arranged in a plurality of rows.

A pair of the first sound absorbers 9A provided in each of the rows can be disposed at, for example, positions opposed to each other with a tire rotation axis therebetween. A pair of the second sound absorbers 9B provided in each of the rows can be disposed at, for example, positions opposed to each other with the tire rotation axis therebetween. Such Helmholtz sound absorbers 9 can be provided in balanced manner or format at the time of rotation of the tire and can suppress generation of vibrations and noise during running with the pneumatic tire 1.

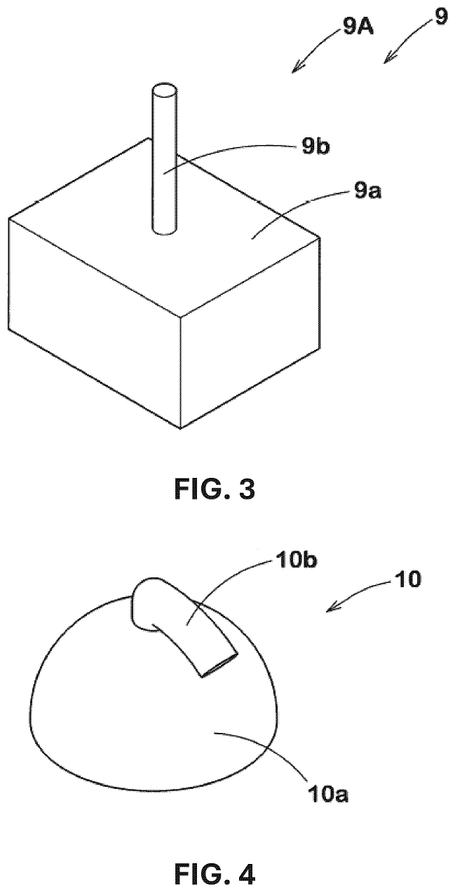

FIG. 3 is a perspective view of the Helmholtz sound absorber 9 according to one or embodiments of the present disclosure. As shown in FIG. 3, the Helmholtz sound absorber 9 can include: a sound absorption chamber 9a having a space therein; and a tube portion 9b connecting the sound absorption chamber 9a and the tire inner cavity to each other. Such a Helmholtz sound absorber 9 can have a different resonance frequency f by adjusting the volume of the sound absorption chamber 9a and the length of the tube portion 9b.

Each of the first sound absorbers 9A according to one or more embodiments of the present disclosure can include a first sound absorption chamber 9a having the first resonance frequency f1. Each of the second sound absorbers 9B can include, for example, a second sound absorption chamber 9c having the second resonance frequency f2.

According to one or more embodiments of the present disclosure, each of the plurality of Helmholtz sound absorbers 9 can be formed of a resin having a shape that does not change at 120° C. or lower, as an example range. Such a Helmholtz sound absorber 9 can maintain the sound absorption performance thereof without any change in the shape even when the temperature of the pneumatic tire 1 becomes high during running at a high speed.

Examples of the material of the Helmholtz sound absorber 9 can include polypropylene (PP), polystyrene (PS), polyethylene terephthalate (PET), polyvinylidene chloride (PVDC), polyvinylidene fluoride (PVDF), polyamides (PA), polycarbonates (PC), polyphenylene sulfide (PPS), polyimides (PI), polyetherimide (PEI), polysulfone (PSF), polysulfone (PSU), polytetrafluoroethylene (PTFE), polychlorotrifluoroethylene (PCTFE), polyamide-imides (PAI), phenol resins (PF), melamine resins (MF), unsaturated polyesters (UP), polyurethane (PU), polydiallyl phthalate (PDAP), silicon resins (SI), epoxy resins (EP), furan-formaldehyde resins (FF), cellulose acetate (CA), cellulose nitrate (CN), cellulose propionate (CP), ethylcellulose (EC), and the like.

The plurality of Helmholtz sound absorbers 9 may further have, for example, at least one resonance frequency f different from the first resonance frequency f1 and the second resonance frequency f2. Such Helmholtz sound absorbers 9 can widely resonate with a frequency band of cavity resonance sound and can more assuredly decrease cavity resonance sound.

The plurality of Helmholtz sound absorbers 9 can be such that unit widths df which are differences between a set of the resonance frequencies f adjacent to each other in a frequency band are substantially equal. Here, the fact that the unit widths df can be substantially equal can mean that the difference between every two unit widths df is 10% or lower of each of said unit widths df. Such Helmholtz sound absorbers 9 can evenly absorb sound over the entire frequency band.

According to one or more embodiments of the present disclosure, each of the unit widths df in the plurality of Helmholtz sound absorbers 9 can be 3 to 10 Hz, as an example range. Such Helmholtz sound absorbers 9 can evenly absorb sound over the entire frequency band without excessively increasing the number of types of the Helmholtz sound absorbers 9.

FIG. 4 is a perspective view of a Helmholtz sound absorber 10 according to one or more embodiments of the present disclosure. As shown in FIG. 4, each of a plurality of the Helmholtz sound absorbers 10 may include, for example, a sound absorption chamber 10a having a hemispherical shape and a tube portion 10b extending along the sound absorption chamber 10a. Such a Helmholtz sound absorber 10 can absorb cavity resonance sound in the tire inner cavity in a balanced manner by adjusting the orientation of the tube portion 10b.

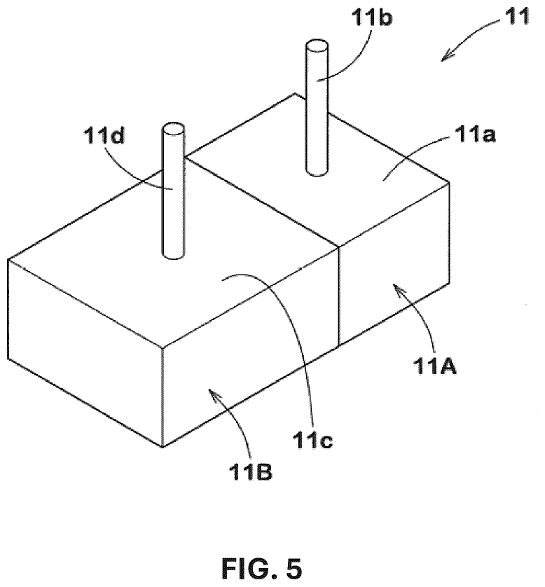

FIG. 5 is a perspective view of a Helmholtz sound absorber 11 according to one or more embodiments of the present disclosure. As shown in FIG. 5, each of a plurality of the Helmholtz sound absorbers 11 may include, for example, at least one first sound absorption chamber 11a having the first resonance frequency f1 and at least one second sound absorption chamber 11c having the second resonance frequency f2. Such Helmholtz sound absorbers 11 can enable one of the Helmholtz sound absorbers 11 to have the plurality of resonance frequencies f. Consequently, the Helmholtz sound absorbers 11 can decrease cavity resonance sound with a simple configuration.

A first sound absorber 11A having the first sound absorption chamber 11a and a second sound absorber 11B having the second sound absorption chamber 11c can be formed to be integrated with each other or otherwise formed in one piece. Such Helmholtz sound absorbers 11 can enable decrease in the number of parts, and furthermore, can decrease cavity resonance sound over a wide frequency band.

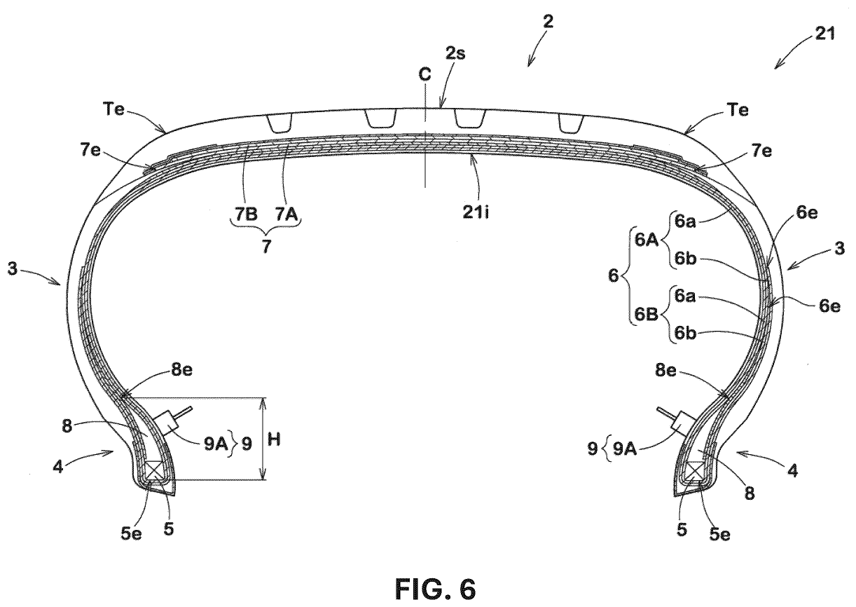

FIG. 6 is a tire meridian cross-sectional view showing a pneumatic tire 21 in the standardized state according to one or more embodiments of the present disclosure. As shown in FIG. 6, similar to the above pneumatic tire 1, the pneumatic tire 21 can include the tread portion 2, the pair of sidewall portions 3, and the pair of bead portions 4. Each of the bead portions 4 can have, for example, the annular bead core 5 extending in the tire circumferential direction and the bead apex 8 extending to the outer side in the tire radial direction from the bead core 5.

The pneumatic tire 21 according to one or more embodiments of the present disclosure can include: the carcass 6 extending between the pair of bead portions 4; and the belt layer 7 disposed, in the tread portion 2, on the outer side in the tire radial direction relative to the carcass 6. The carcass 6 can include, for example, the two carcass plies 6A and 6B each having the body portion 6a and the turned-up portions 6b. The belt layer 7 can include, for example, the two belt plies 7A and 7B. Similar to the above pneumatic tire 1, the pneumatic tire 21 can include a tire inner cavity surface 21i which is located inward of the carcass 6 and which delimits the tire inner cavity.

Similar to the above pneumatic tire 1, the pneumatic tire 21 according to one or more embodiments of the present disclosure can include the plurality of Helmholtz sound absorbers 9 disposed on the tire inner cavity surface 21i. Each of the plurality of Helmholtz sound absorbers 9 can be disposed on the inner side in the tire axial direction relative to at least one of either of the sidewall portions 3 and either of the bead portions 4. Such a Helmholtz sound absorber 9 can make it possible to, even when the tread portion 2 is deformed upon contact with the ground, suppress shift of the Helmholtz sound absorber 9 itself and suppress resonance sound generated from the Helmholtz sound absorber 9 owing to impact upon the contact with the ground.

Each of the plurality of Helmholtz sound absorbers 9 can be disposed on the inner side in the tire axial direction relative to either of the bead portions 4. Such a Helmholtz sound absorber 9 may not raise a concern that the Helmholtz sound absorber 9 might generate resonance sound owing to impact upon contact with the ground. Thus, the Helmholtz sound absorber 9 can assuredly decrease cavity resonance sound.

Each of the plurality of Helmholtz sound absorbers 9 can be disposed on the inner side in the tire axial direction within a range extending from an inner end 5e in the tire radial direction of either of the bead cores 5 to an outer end 8e in the tire radial direction of a corresponding one of the bead apexes 8, for example. That is, each of the plurality of Helmholtz sound absorbers 9 can be disposed within a range of a height H from the inner end 5e of either of the bead cores 5 to the outer end 8e of the corresponding one of the bead apexes 8. Such a Helmholtz sound absorber 9 can assuredly decrease cavity resonance sound since the Helmholtz sound absorber 9 can be disposed within such a range that a high rigidity is imparted.

In a case where each of the plurality of Helmholtz sound absorbers 9 is disposed on the inner side in the tire axial direction relative to either of the sidewall portions 3, the Helmholtz sound absorber 9 can be disposed on the inner side in the tire radial direction relative to either of the outer ends 6e of each of the carcass plies 6A and 6B. Such a Helmholtz sound absorber 9 can contribute to suppression of resonance sound generated from the Helmholtz sound absorber 9 owing to impact upon contact with the ground.

Although the particularly preferred embodiments of the present disclosure have been described in detail above, one or more embodiments of the present disclosure are not limited to the above-described embodiments, and various modifications can be implemented.

### Examples

On the basis of FIG. 1 to FIG. 3 and FIG. 6, pneumatic tires in Examples each having a tire size of 215/55R17 were produced as samples according to the specifications indicated in Table 1. In a Comparative Example, a pneumatic tire that had the same size and that had no Helmholtz sound absorbers was produced as a sample. Noise performances at different running speeds were tested by using the pneumatic tires produced as samples.

### <Noise Performances>

Each of the pneumatic tires produced as samples was mounted to a tester on a support, and running was performed at a speed of 20 km/h, a speed of 60 km/h, and a speed of 150 km/h. At the time of the running at each of these speeds, axial forces were measured, and a low-frequency-side sound pressure and a high-frequency-side sound pressure of cavity resonance sound were obtained. The results are indicated as indexes with results in the Comparative Example being regarded as 100. A smaller numerical value indicates a lower sound pressure and a better noise performance.

The results of the tests are indicated in Table 1.

TABLE 1

| | Compar- | | | | |
|---|---|---|---|---|---|
| | ative | | | | |
| | Example | Example | Example | Example | Example |
| | 1 | 1 | 2 | 3 | 4 |
| Positions of | — | Ground- | Bead | Ground- | Bead |
| Helmholtz sound | | contact | portions | contact | portions |
| absorbers | | surface | (FIG. 6) | surface | (FIG. 6) |
| | | (FIG. 1) | | (FIG. 1) | |
| Resonance frequency | — | 210 | 210 | 225 | 225 |
| of first sound | | | | | |
| absorber (Hz) | | | | | |
| Resonance frequency | — | 201 | 201 | 195 | 195 |
| of second sound | | | | | |
| absorber (Hz) | | | | | |
| Resonance frequency | — | — | — | 220 | 220 |
| of third sound | | | | | |
| absorber (Hz) | | | | | |
| Resonance frequency | — | — | — | 215 | 215 |
| of fourth sound | | | | | |
| absorber (Hz) | | | | | |
| Resonance frequency | — | — | — | 210 | 210 |
| of fifth sound | | | | | |
| absorber (Hz) | | | | | |
| Resonance frequency | — | — | — | 205 | 205 |
| of sixth sound | | | | | |
| absorber (Hz) | | | | | |
| Resonance frequency | — | — | — | 200 | 200 |
| of seventh sound | | | | | |
| absorber (Hz) | | | | | |
| Low-frequency-side | 100 | 80 | 70 | 50 | 50 |
| noise performance at | | | | | |
| speed of 20 Km/h | | | | | |
| (index) | | | | | |
| High-frequency-side | 100 | 70 | 60 | 50 | 50 |
| noise performance at | | | | | |
| speed of 20 Km/h | | | | | |
| (index) | | | | | |
| Low-frequency-side | 100 | 70 | 60 | 50 | 50 |
| noise performance at | | | | | |
| speed of 60 Km/h | | | | | |
| (index) | | | | | |
| High-frequency-side | 100 | 70 | 60 | 50 | 50 |
| noise performance at | | | | | |
| speed of 60 Km/h | | | | | |
| (index) | | | | | |
| Low-frequency-side | 100 | 70 | 60 | 50 | 50 |
| noise performance at | | | | | |
| speed of 150 Km/h | | | | | |
| (index) | | | | | |
| High-frequency-side | 100 | 80 | 70 | 50 | 50 |
| noise performance at | | | | | |
| speed of 150 Km/h | | | | | |
| (index) | | | | | |

As a result of the tests, it has been confirmed that the pneumatic tire in each of the Examples has a better noise performance at each of the running speeds than in the Comparative Example and can decrease cavity resonance sound with a simple configuration that involves merely attaching Helmholtz sound absorbers.

### [Additional Notes]

One or more embodiments of present disclosure can be as follows.

### [Present Disclosure 1]

A pneumatic tire comprising:
a plurality of Helmholtz sound absorbers disposed on a tire inner cavity surface, wherein
the plurality of Helmholtz sound absorbers have a first resonance frequency as a maximum resonance frequency and a second resonance frequency as a minimum resonance frequency, and
a difference between the first resonance frequency and the second resonance frequency is 10 to 90 Hz.

### [Present Disclosure 2]

The pneumatic tire according to Present Disclosure 1, wherein
the first resonance frequency is 130 to 350 Hz, and
the second resonance frequency is 120 to 340 Hz.

### [Present Disclosure 3]

The pneumatic tire according to Present Disclosure 1 or 2, wherein the plurality of Helmholtz sound absorbers are arranged away from each other.

### [Present Disclosure 4]

The pneumatic tire according to any one of Present Disclosures 1 to 3, wherein each of the plurality of Helmholtz sound absorbers is formed of a resin having a shape that does not change at 120° C. or lower.

### [Present Disclosure 5]

The pneumatic tire according to any one of Present Disclosures 1 to 4, wherein the plurality of Helmholtz sound absorbers further have at least one resonance frequency different from the first resonance frequency and the second resonance frequency.

### [Present Disclosure 6]

The pneumatic tire according to any one of Present Disclosures 1 to 5, wherein the plurality of Helmholtz sound absorbers are such that unit widths which are differences between a set of the resonance frequencies adjacent to each other in a frequency band are substantially equal.

### [Present Disclosure 7]

The pneumatic tire according to any one of Present Disclosures 1 to 6, wherein each of the unit widths is 3 to 10 Hz.

### [Present Disclosure 8]

The pneumatic tire according to any one of Present Disclosures 1 to 7, wherein each of the plurality of Helmholtz sound absorbers includes at least one first sound absorption chamber having the first resonance frequency and at least one second sound absorption chamber having the second resonance frequency.

### [Present Disclosure 9]

The pneumatic tire according to any one of Present Disclosures 1 to 8, wherein a first sound absorber having the first sound absorption chamber and a second sound absorber having the second sound absorption chamber are formed to be integrated with each other.

### [Present Disclosure 10]

The pneumatic tire according to any one of Present Disclosures 1 to 9, wherein the difference between the first resonance frequency and the second resonance frequency is 10 to 60 Hz.

### [Present Disclosure 11]

The pneumatic tire according to any one of Present Disclosures 1 to 10, further comprising:
a tread portion;
a pair of sidewall portions each extending to an inner side in a tire radial direction from a corresponding one of both ends in a tire axial direction of the tread portion; and
a pair of bead portions each located on the inner side in the tire radial direction relative to a corresponding one of the pair of sidewall portions, wherein
each of the plurality of Helmholtz sound absorbers is disposed on an inner side in the tire axial direction relative to at least one of either of the sidewall portions and either of the bead portions.

### [Present Disclosure 12]

The pneumatic tire according to any one of Present Disclosures 1 to 11, wherein each of the plurality of Helmholtz sound absorbers is within a range of a tire tread width centered on an equator of the tire.

### [Present Disclosure 13]

The pneumatic tire according to any one of Present Disclosures 1 to 12, wherein
of the plurality of Helmholtz sound absorbers a first set of the Helmholtz sound absorbers have the first resonance frequency,
of the plurality of Helmholtz sound absorbers a second set of the Helmholtz sound absorbers, different from the Helmholtz sound absorbers of the first set, have the second resonance frequency,
a total number of the Helmholtz sound absorbers of the first set is a first even number, and
a total number of the Helmholtz sound absorbers of the second set is a second even number.

### [Present Disclosure 14]

The pneumatic tire according to any one of Present Disclosures 1 to 13, wherein the first resonance frequency is 210 Hz and the second resonance is 201 Hz.

### [Present Disclosure 15]

The pneumatic tire according to any one of Present Disclosures 1 to 14, wherein the first resonance frequency is 225 Hz and the second resonance is 195 Hz.

### [Present Disclosure 16]

The pneumatic tire according to any one of Present Disclosures 1 to 15, wherein the plurality of Helmholtz sound absorbers are evenly spaced on the tire inner cavity surface in a circumferential direction of the pneumatic tire.

### [Present Disclosure 17]

The pneumatic tire according to any one of Present Disclosures 1 to 16, wherein each of the plurality of Helmholtz sound absorbers is on the tire inner cavity surface within a range extending from an inner end in a tire radial direction of either bead core of the pneumatic tire to an outer end in the tire radial direction of a corresponding bead apex of the pneumatic tire.

### [Present Disclosure 18]

The pneumatic tire according to any one of Present Disclosures 1 to 17, wherein each of the plurality of Helmholtz sound absorbers is on the tire inner cavity surface within a range of a height H from an inner end of either bead core of the pneumatic tire to an outer end of a corresponding bead apex of the pneumatic tire. [Present Disclosure 19]

The pneumatic tire according to any one of Present Disclosures 1 to 18, wherein the pneumatic tire is configured to rotate at a speed of 20 Km/h to 150 Km/h.

What is claimed is:

1. A pneumatic tire comprising:
a plurality of Helmholtz sound absorbers on a tire inner cavity surface, wherein
the plurality of Helmholtz sound absorbers have a first resonance frequency as a maximum resonance frequency and a second resonance frequency as a minimum resonance frequency, and
a difference between the first resonance frequency and the second resonance frequency is 10 to 90 Hz.

2. The pneumatic tire according to claim 1, wherein
the first resonance frequency is 130 to 350 Hz, and
the second resonance frequency is 120 to 340 Hz.

3. The pneumatic tire according to claim 1, wherein the plurality of Helmholtz sound absorbers are arranged away from each other.

4. The pneumatic tire according to claim 1, wherein each of the plurality of Helmholtz sound absorbers is formed of a resin having a shape that does not change at 120° C. or lower.

5. The pneumatic tire according to claim 1, wherein the plurality of Helmholtz sound absorbers further have at least one resonance frequency different from the first resonance frequency and the second resonance frequency.

6. The pneumatic tire according to claim 5, wherein the plurality of Helmholtz sound absorbers are such that unit widths which are differences between a set of the resonance frequencies adjacent to each other in a frequency band are substantially equal.

7. The pneumatic tire according to claim 6, wherein each of the unit widths is 3 to 10 Hz.

8. The pneumatic tire according to claim 1, wherein each of the plurality of Helmholtz sound absorbers includes at least one first sound absorption chamber having the first resonance frequency and at least one second sound absorption chamber having the second resonance frequency.

9. The pneumatic tire according to claim 8, wherein a first sound absorber having the first sound absorption chamber and a second sound absorber having the second sound absorption chamber are integrated with each other.

10. The pneumatic tire according to claim 1, wherein the difference between the first resonance frequency and the second resonance frequency is 10 to 60 Hz.

11. The pneumatic tire according to claim 1, further comprising:
a tread portion;
a pair of sidewall portions each extending to an inner side in a tire radial direction from a corresponding one of both ends in a tire axial direction of the tread portion; and
a pair of bead portions each located on the inner side in the tire radial direction relative to a corresponding one of the pair of sidewall portions, wherein
each of the plurality of Helmholtz sound absorbers is on an inner side in the tire axial direction relative to at least one of either of the pair of sidewall portions and either of the pair of bead portions.

12. The pneumatic tire according to claim 1, wherein each of the plurality of Helmholtz sound absorbers is within a range of a tire tread width centered on an equator of the tire.

13. The pneumatic tire according to claim 1, wherein
of the plurality of Helmholtz sound absorbers a first set of the Helmholtz sound absorbers have the first resonance frequency,
of the plurality of Helmholtz sound absorbers a second set of the Helmholtz sound absorbers, different from the Helmholtz sound absorbers of the first set, have the second resonance frequency,
a total number of the Helmholtz sound absorbers of the first set is a first even number, and
a total number of the Helmholtz sound absorbers of the second set is a second even number.

14. The pneumatic tire according to claim 13, wherein the first resonance frequency is 210 Hz and the second resonance is 201 Hz.

15. The pneumatic tire according to claim 13, wherein the first resonance frequency is 225 Hz and the second resonance is 195 Hz.

16. The pneumatic tire according to claim 1, wherein the plurality of Helmholtz sound absorbers are evenly spaced on the tire inner cavity surface in a circumferential direction of the pneumatic tire.

17. The pneumatic tire according to claim 1, wherein each of the plurality of Helmholtz sound absorbers is on the tire inner cavity surface within a range extending from an inner end in a tire radial direction of either bead core of the pneumatic tire to an outer end in the tire radial direction of a corresponding bead apex of the pneumatic tire.

18. The pneumatic tire according to claim 1, wherein each of the plurality of Helmholtz sound absorbers is on the tire inner cavity surface within a range of a height H from an inner end of either bead core of the pneumatic tire to an outer end of a corresponding bead apex of the pneumatic tire.

19. The pneumatic tire according to claim 1, wherein the pneumatic tire is configured to rotate at a speed of 20 Km/h to 150 Km/h.
